(19) United States
(12) Patent Application Publication
(10) Pub. No.: US 2016/0242033 A1
(43) Pub. Date: Aug. 18, 2016

(54) COMMUNICATION SERVICE USING METHOD AND ELECTRONIC DEVICE SUPPORTING THE SAME

(71) Applicant: Samsung Electronics Co., Ltd., Gyeonggi-do (KR)

(72) Inventors: Bu Seop JUNG, Gyeonggi-do (KR); Hyuk KANG, Gyeonggi-do (KR); Dong Il SON, Gyeonggi-do (KR)

(73) Assignee: Samsung Electronics Co., Ltd.

(21) Appl. No.: 15/043,076

(22) Filed: Feb. 12, 2016

(30) Foreign Application Priority Data
Feb. 12, 2015 (KR) 10-2015-0021807

(51) Int. Cl. H04W 12/06; H04W 76/02; H04L 29/06; H04W 4/00

(52) U.S. Cl. CPC H04W 12/06; H04W 4/008; H04W 76/02; H04L 63/08

(57) ABSTRACT

Disclosed is an electronic device including a memory that stores network connection service use available remote authentication information, a first short-range communication module that establishes a short-range communication channel with an external electronic device, and a processor functionally connected to the memory and the first short-range communication module, wherein the processor controls to establish the short-range communication channel with the external electronic device and transmit the network connection service use available remote authentication information to the external electronic device in response to a specified schedule or a user input.

### PRIORITY

This application claims priority under 35 U.S.C. §119(a) to a Korean Patent Application filed on Feb. 12, 2015 in the Korean Intellectual Property Office and assigned Serial No. 10-2015-0021807, the contents of which are incorporated herein by reference.

### BACKGROUND

1. Field of the Disclosure

The present disclosure relates to a communication service use.

2. Description of the Related Art

At least one service provider providing communication service supports a subscribed electronic device to use a communication service based on a communication network. For example, a plurality of service providers supports the wide fidelity (WiFi) communication network in a same or different geographical location.

In the above-mentioned communication environment, a typical electronic device may be limited to use communication service through a communication network that a service provider specifies. Accordingly, an electronic device unsubscribed to a specified network service cannot use a communication network that a corresponding service provider supports. As such, there is a need in the art for a method for an electronic device unsubscribed to a specified network service to use a communication network that a corresponding service provider supports.

### SUMMARY

The present disclosure has been made to address the above-mentioned problems and disadvantages, and to provide at least the advantages described below.

Accordingly, an aspect of the present disclosure is to provide a communication service using method for using an unsubscribed communication network through remote authentication and an electronic device supporting the same.

In accordance with an aspect of the present disclosure, an electronic device includes a memory that stores network connection service use available remote authentication information, a first short-range communication module that establishes a short-range communication channel with an external electronic device, and a processor functionally connected to the memory and the first short-range communication module, wherein the processor controls to establish the short-range communication channel with the external electronic device and transmit the network connection service use available remote authentication information to the external electronic device in response to a specified schedule or a user input.

In accordance with another aspect of the present disclosure, an electronic device operating method includes establishing, by an electronic device, a short-range security communication channel with an external electronic device; and transmitting, to the external electronic device, network connection service use available remote authentication information, in response to a specified schedule or a user input, based on the short-range security communication channel.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates a communication service using environment according to embodiments of the present disclosure;

FIG. 2 illustrates a first electronic device according to embodiments of the present disclosure;

FIG. 3 illustrates a second electronic device according to embodiments of the present disclosure;

FIG. 4 illustrates a first electronic device operating method according to embodiments of the present disclosure;

FIG. 5 illustrates a second electronic device operating method according to embodiments of the present disclosure;

FIG. 6A illustrates a remote authentication procedure according to embodiments of the present disclosure;

FIG. 6B illustrates a remote authentication procedure according to another embodiment of the present disclosure;

FIG. 6C illustrates a following up remote authentication procedure according to another embodiment of the present disclosure of FIG. 6B;

FIG. 7 illustrates a screen interface of a first electronic device according to embodiments of the present disclosure;

FIG. 8 illustrates a screen interface of a second electronic device according to embodiments of the present disclosure;

FIG. 9 illustrates a plurality of remote authentication functions according to embodiments of the present disclosure; and

FIG. 10 illustrates a remote authentication information sharing environment according to embodiments of the present disclosure.

### DETAILED DESCRIPTION OF EMBODIMENTS OF THE DISCLOSURE

Hereinafter, embodiments of the present disclosure are disclosed with reference to the accompanying drawings. However, the present disclosure is not limited to a specific embodiment and it should be understood that the present disclosure covers all the modifications, equivalents, and/or alternatives of this disclosure that are within the scope of the appended claims and their equivalents. With respect to the descriptions of the drawings, like reference numerals refer to like elements. A detailed description of known functions and configurations will be omitted for the sake of clarity and conciseness.

The terms “include,” “comprise,” and “have”, or “may include,” or “may comprise” and “may have” used herein indicate disclosed functions, operations, or existence of elements but do not exclude other functions, operations or elements.

For instance, the expressions “A or B”, or “at least one of A or/and B” may indicate A, B, or both A and B. For instance, the expressions “A or B”, or “at least one of A or/and B” may indicate (1) at least one A, (2) at least one B, or (3) both at least one A and at least one B.

The terms such as “1st”, “2nd”, “first”, “second”, and the like used herein may refer to modifying various different elements of embodiments of the present disclosure, but do not limit the elements. For instance, “a first user device” and “a second user device” may indicate different users regardless of the order or the importance. For example, a first component may be referred to as a second component and vice versa without departing from the scope of the present disclosure.

In embodiments of the present disclosure, it will be understood that when a component (for example, a first component) is referred to as being “(operatively or communicatively) coupled with/to” or “connected to” another component (for example, a second component), the component may be directly connected to the other component or connected through another component (for example, a third component). In embodiments of the present disclosure, it will be understood that when the first component is referred to as being “directly connected to” or “directly access” the second component, a third component does not exist between the first and second components.

The expression “configured to” used in embodiments of the present disclosure may be interchangeably used with “suitable for”, “having the capacity to”, “designed to”, “adapted to”, “made to”, or “capable of” according to a situation, for example. The term “configured to” may not necessarily indicate “specifically designed to” in terms of hardware. Instead, the expression “a device configured to” in some situations may indicate that the device and another device or part thereof are “capable of”. For example, “a processor configured to perform A, B, and C” in a phrase may indicate an embedded processor for performing a corresponding operation or a generic-purpose processor such as a CPU or application processor for performing corresponding operations by executing at least one software program stored in a memory device.

Terms used in embodiments of the present disclosure are used to describe specific embodiments of the present disclosure, and are not intended to limit the scope of other embodiments. The terms of a singular form include plural forms unless they have a clearly different meaning in the context. Unless otherwise indicated, all the terms used herein, which include technical or scientific terms, may have the same meaning that is generally understood by a person skilled in the art. In general, the terms defined in the dictionary should be considered to have the same meaning as the contextual meaning of the related art, and, unless clearly defined herein, should not be understood abnormally or as having an excessively formal meaning. In any case, even terms defined in this specification cannot be interpreted as excluding embodiments of the present disclosure.

The term “user” in this disclosure may refer to a person using an electronic device or a device using an electronic device, such as an artificial intelligence electronic device.

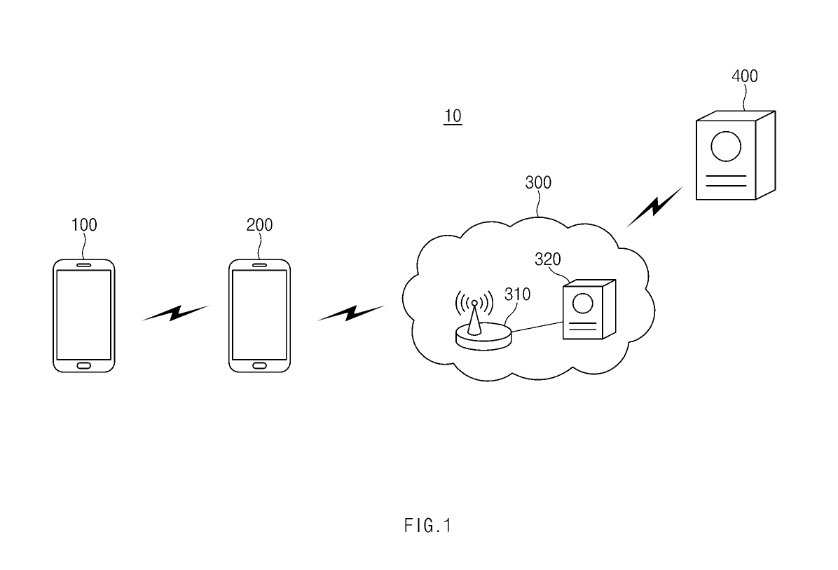

FIG. 1 illustrates a communication service using environment according to embodiments of the present disclosure.

Referring to FIG. 1, a communication service using environment 10 includes a first electronic device 100, a second electronic device 200, a network 300, and an authentication server device 400.

The communication service using environment 10 supports the second electronic device 200 not subscribed to a specified service provider to perform short-range communication connection, such as a Bluetooth® (BT) low energy (BLE) beacon, WiFi neighbor awareness networking (NAN), ZigBee®, and near field communication (NFC) with the first electronic device 100. The communication service using environment 10 supports the second electronic device 200 to obtain an authority to use a communication network supported by a specified service provider by using remote authentication information of the first electronic device 100.

The first electronic device 100 uses a communication service provided from a specified service provider. The first electronic device 100 registers subscription information, such as subscriber identity module (SIM) information for using the communication network in the authentication server device 400. The subscription information includes contract option information processed in a service subscription operation and identification information, such as international mobile equipment identity (IMEI) and international mobile subscriber identity (IMSI).

According to an embodiment of the present disclosure, the first electronic device 100 includes remote authentication information such as the device identification information and connection information supporting the communication service use of the second electronic device 200. The first electronic device 100 stores remote authentication information in a specified memory area such as a SIM card, an embedded universal integrated circuit card (eUICC), and an embedded secured element (eSE).

The first electronic device 100 provides remote authentication information necessary for communication network use to the short-range communication connected second electronic device 200. During this operation, the first electronic device 100 converts remote authentication information into a message according to short-range communication channel standards, and provides a message corresponding to corresponding standards to the second electronic device 200. The first electronic device 100 provides remote authentication information to the second electronic device 200 through a security short-range communication channel. The first electronic device 100 and the second electronic device 200 apply a security function to transmitted/received information by performing encryption and decryption on remote authentication information.

The second electronic device 200 searches for the network 300 or does not have authentication information of the authentication server device 400 connectable to the network 300 due to an unsubscribed state. The second electronic device 200 establishes a short-range communication channel with the first electronic device 100, which has authentication information for using a communication network relating to the authentication server device 400 or is capable of generating authentication information. The second electronic device 200 obtains the authentication of the authentication server device 400 by using the authentication information of the first electronic device 100 and based on this, obtains an authority for using a communication network of a specified service provider.

The network 300 includes an access point (AP) 310 for supporting at least one electronic device access. According to an embodiment of the present disclosure, the network 300 includes AP 310 for supporting Hotspot 2.0, such as Passpoint. The network 300 includes an access network query protocol (ANQP) server device 320 for allowing the first electronic device 100 or the second electronic device 200 to obtain external network information.

The Hotspot 2.0 technique is based on the IEEE 802.11u standards and provides improved security by basically using the security of a WPA2-Enterprise method. A data off-loading function of a cellular network may also be provided. In relation to the network 300, when an electronic device queries ANQP information through AP 310, AP 310 queries the authentication server device 400 about corresponding information through the ANQP server device 320 and re-sends the response of the authentication server device 400 to the electronic device. During this operation, the network 300 provides, to an electronic device, network access identifier (NAI) realm or public land mobile network (PLMN) information corresponding to information of a service provider providing Hotspot 2.0 from the authentication server device 400 that is an external information server.

The network 300 provides, to an electronic device, information on an extensible authentication protocol (EAP) authentication method for connecting to the Hotspot 2.0 support AP 310. An electronic device may automatically connect to a matching network in comparison with an IMSI value that is already stored or obtained from SIM information. An EAP connection method that is basically used in the network 300 for supporting Hotspot 2.0 may be an EAP-SIM/AKA/AKA′ method, where AKA refers to an authentication and key agreement. An electronic device performs basic EAP processing for EAP authentication and a final encryption processing task for authenticating credentials by operating a SIM or universal SIM (USIM)-based communication.

The authentication server device 400 performs information processing necessary for an access of an electronic device through the ANQP server device 320. For example, the authentication server device 400 performs authentication processing and processes internet connection permission necessary for communication service use of an electronic device by processing a message from the ANQP server device 320.

As mentioned above, the communication service using environment 10 processes a remote authentication of another electronic device by using an electronic device subscribed to a communication network operated by a specified service provider and thus, supports to use communication service. The communication service using environment 10 of the present disclosure supports a broader or more improved communication service use by sharing authentication information using communication networks of different service providers with electronic devices in a remotely authenticated manner. As mentioned above, security may be enhanced in a method for sharing short-range network connection with a peripheral device by expanding a network connection range of an electronic device based on a method for remotely authenticating a peripheral device and not concurrently storing direct connection information or remote authentication information.

As mentioned above, in the communication service using environment 10, the network 300 includes a Hotspot 2.0 network that is a technique for automatically accessing a WiFi network. The second electronic device 200 accesses the Hotspot 2.0 network and the first electronic device 100 has a credential such as a SIM of a wearable electronic device, accessible to the network. Although a configuration is described above that the authentication server device 400 is separated from the network 300, the network 300 may include the authentication server device 400. Although an example using the Hotspot 2.0 network is described above, any other network utilizing the type of credential stored in a remote authentication device may be included in the network 300.

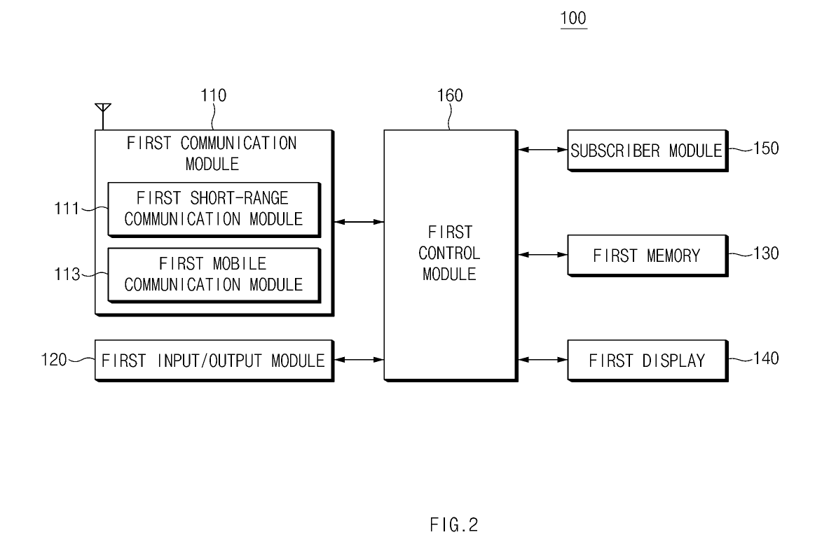

FIG. 2 illustrates a first electronic device according to embodiments of the present disclosure.

Referring to FIG. 2, a first electronic device 100 includes a first communication module 110, a first input/output module 120, a first memory 130, a first display 140, a subscriber module 150, and a first control module 160 (or a first processor).

in order to provide remote authentication network information to the second electronic device 200 according to a request of the second electronic device 200 or a setting, the first electronic device 100 is connected to the second electronic device 200 and performs remote authentication through the second electronic device 200. The first electronic device 100 may be a wearable electronic device including a SIM.

The first communication module 110 supports a communication channel establishment of the first electronic device 100, and includes a first short-range communication module 111 and a first mobile communication module 113.

The first short-range communication module 111 includes a short-range communication module for establishing a short-range communication channel with the second electronic device 200. For example, the first short-range communication module 111 includes at least one of various communication modules such as a BT, BLE, Zigbee®, WiFi direct, WiFi NAN, or an NFC communication module. The first short-range communication module 111 receives a remote authentication request message from the second electronic device 200. In response to a control of the first control module 160, the first short-range communication module 111 transmits authentication information relating to remote authentication to the second electronic device 200.

The first mobile communication module 113 may be a communication module for accessing the network 300 based on the subscriber module 150. For example, the first mobile communication module 113 may be a WiFi communication module or a communication module using a mobile communication network. The first mobile communication module 113 accesses the network 300 by performing an authentication process based on information written in the registered subscriber module 150. The first mobile communication module 113 and the first short-range communication module 111 may operate together or separate from each other. For example, the first short-range communication module 111 establishes a communication channel with the second electronic device 200 irrespective of turn-on or turn-off of the first mobile communication module 113.

The first input/output module 120 processes at least one of an input function for processing a user input of the first electronic device 100 and an output function for outputting audio information, lamp, or vibration according to a function operation. According to an embodiment of the present disclosure, the first input/output module 120 includes various input means such as a physical button, a key pad, and a touch pad and generates an input signal according to a user input. For example, The first input/output module 120 generates an input signal for controlling turn on or turn off of an electronic device, an input signal relating to a short range communication channel establishment with the second electronic device 200, and an input signal relating to remote authentication processing of the second electronic device 200 in correspondence to a user input or set scheduling information. The generated input signal is delivered to the first control module 160 and is used as an instruction for related function processing. The first input/output module 120 includes a microphone for collecting surrounding audio signals and a speaker for outputting an audio generated according to a function operation. The first input/output module 120 includes at least one of a lamp for outputting a specified color light in correspondence to a specified pattern and a vibration module for providing vibration in a specified pattern according to function performance.

The first memory 130 stores various programs and data relating to an operation of the first electronic device 100, such as operating system (OS), middleware, application protocol interface (API), and applications for operations of the first electronic device 100. The first memory 130 stores a program relating to an operation of the first short-range communication module 111, a program relating to remote authentication function processing, and authentication information necessary for remote authentication such as device identification information, connection network information, and connection authentication information. The device identification information in the authentication information is fixed or predefined and the connection network information or the connection authentication information may be received from the network 300 or may be newly generated based on a specified key.

The first memory 130 includes an authentication processing list of at least one remote authentication processed second electronic device 200. The authentication processing list is used for automatically performing remote authentication processing of the second electronic device 200 connected through the first short-range communication module 111. The authentication processing list is outputted through the first display 140 and may be reset or partially deleted corresponding to a user control.

The first display 140 outputs at least one user interface according to a function operation of the first electronic device 100, such as the standby screen, home screen, menu screen, and icon arrangement screen of the first electronic device 100. The first display 140 outputs a screen relating to communication connection and remote authentication of the second electronic device 200. A remote authentication processing function of the first electronic device 100 may be performed through background processing according to a user setting or a design setting. In this case, the first display 140 omits a screen output relating to remote authentication processing.

The subscriber module 150 stores subscriber information necessary for communication service use of the first electronic device 100. The subscriber module 150 may be a hardware or software module for providing security, such as a SIM card, eUICC, and eSE chip. According to embodiments of the present disclosure, when an electronic device is prepared in a form of including Trustzone, the subscriber module 150 may be stored in the Trustzone in a form including at least one of a hardware form and a software form. The subscriber module 150 includes a smart OS for security connection with the network 300 or the authentication server device 400 in a remote authentication process.

The first control module 160 processes and delivers signals necessary for operations of the first electronic device 100 or generates control signals. The first control module 160 includes at least one processor. When receiving a short-range communication establishment request with the second electronic device 200, the first control module 160 automatically establishes a short-range communication channel according to a setting or outputs a short-range communication channel establishment request reception through the first display 140. When outputting a request reception, the first control module 160 controls a short-range communication channel establishment with the second electronic device 200 in response to a user input.

When receiving a remote authentication request from the second electronic device 200, the first control module 160 performs remote authentication processing automatically or in correspondence to a user input. For example, when the second electronic device 200 previously allows authentication processing by checking an authentication processing list, the first control module 160 performs processing necessary for remote authentication without an additional user check. Alternatively, each time a remote authentication request is received from an external electronic device according to a setting, the first control module 160 performs processing to process a user check procedure.

In relation to remote authentication processing, the first control module 160 transmits, to the second electronic device 200, information on the network 300 that the first electronic device 100 accesses based on information stored in the subscriber module 150. When receiving authentication check information of a network from the second electronic device 200, the first control module 160 generates an authentication key by using a key stored in the subscriber module 150 or in a specified place and provides the authentication key to the second electronic device 200. Then, the first control module 160 performs a control to release a short-range communication channel with the second electronic device 200 or maintains a short-range communication channel according to a setting. After a specified time elapses, the first control module 160 generates a new authentication key which it transmits to the second electronic device 200 in response to a request of the second electronic device 200 or the network 300.

The following are aspects according to embodiments of the present disclosure, as described above:

An electronic device 100 includes a memory that stores network connection service use available remote authentication information, a first short-range communication module that establishes a short-range communication channel with an external electronic device, and a processor functionally connected to the memory and the first short-range communication module, wherein the processor establishes a short-range communication channel with the external electronic device and transmits the network connection service use available remote authentication information to the external electronic device according to a specified schedule or according to a user input.

The control module provides the remote authentication information to the external electronic device in a specific period.

When receiving a remote authentication request message, the control module transmits the remote authentication information to the external electronic device that transmits the remote authentication request message.

When receiving a plurality of remote authentication request messages, the control module provides, to the external electronic devices, remote authentication information corresponding each of the remote authentication request messages.

When establishing a short-range security communication channel with a specified external electronic device, the control module automatically transmits the remote authentication information to the specified external electronic device.

The control module outputs information relating to the remote authentication request of the external electronic device.

When an input signal for accepting the remote authentication request occurs, the control module transmits the remote authentication information to the external electronic device.

The control module transmits remote authentication information that limits network connection characteristics of the external electronic device according to a user setting or according to a design method.

The control module transmits remote authentication information that limits network connection characteristics according to a type of the external electronic device.

The control module outputs a screen interface for adjusting network connection characteristics.

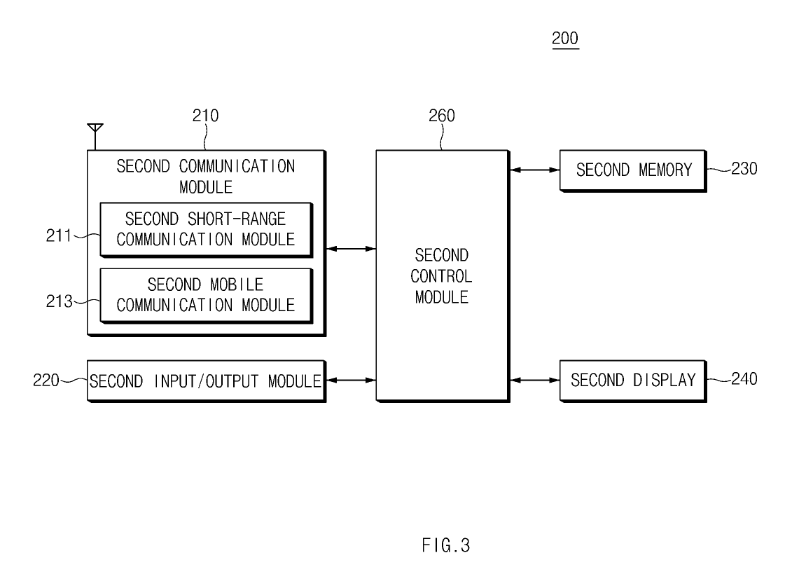

FIG. 3 illustrates a second electronic device according to embodiments of the present disclosure.

Referring to FIG. 3, a second electronic device 200 includes a second communication module 210, a second input/output module 220, a second memory 230, a second display 240, and a second control module 260 (or processor). The second electronic device 200 includes a second subscriber module using a communication network of a service provider different from that of the first subscriber module 150 included in the first electronic device 100.

In performing a WiFi EAP authentication, the second electronic device 200 forwards an EAP authentication message with the network 300 to the first electronic device 100. The second electronic device 200 transmits, to the network 300, the EAP authentication message provided from the first electronic device 100, or performs EAP authentication with the network 300 by using an authentication key provided from the first electronic device 100.

The second communication module 210 supports a communication channel establishment of the second electronic device 200, and includes a second short-range communication module 211 for establishing a communication channel with the first short-range communication module 111 of the first electronic device 100. The first short-range communication module 111 includes a communication module compatible with or identical to the second short-range communication module 211. The second communication module 210 establishes a communication channel with the first electronic device 100 and transmits a remote authentication request message. The second communication module 210 receives an authentication completion message or an authentication key from the first electronic device 100. After authentication completion with the network 300, the second short-range communication module 211 releases or maintains a short-range communication channel with the first electronic device 100 according to a setting or in correspondence to a user control.

The second communication module 210 includes a second mobile communication module 213 for searching for the network 300, such as the WiFi network. The second communication module 213 may be identical to or different from the first mobile communication module 113. The second mobile communication module 213 processes signal transmission/reception necessary for remote authentication with the network 300, and then establishes a communication channel with the network 300 and transmits/receives data relating to a communication service use supported by the corresponding network 300. The second mobile communication module 213 releases an established communication channel in correspondence to a user input or a control of the network 300.

The second input/output module 220 performs the user input processing or information output of the second electronic device 200, and includes a microphone for collecting audio signals and a speaker for outputting audio signals. When audio information is included in information received from the network 300 based on the second mobile communication module 213, the speaker of the second input/output module 220 outputs corresponding audio information. According to embodiments of the present disclosure, the second input/output module 220 may further include a lamp that flashes and a vibration module that vibrates in correspondence to a specified information output.

The second memory 230 stores at least one program or data necessary for an operation of the second electronic device 200. For example, the second memory 230 may store a program necessary for an operation of the second short-range communication module 211. The second memory 230 includes at least one program (for example, a game program, a messenger program, a web browser, and so on) operating based on the network 300, and stores an authentication message or an authentication key received from the first electronic device 100.

The second display 240 outputs at least one screen or user interface relating to an operation of the second electronic device 200. For example, the second display 240 outputs type information of the accessible network 300 according to an operation of the second mobile communication module 213. The type information of the network 300 to which the second electronic device 200 is accessible may be changed according to a connection state of a remotely authenticated electronic device. The second display 240 outputs a webpage provided from specific server devices connected to the accessed network 300.

The second control module 260 processes and delivers signals necessary for operations of the second electronic device 200 or generates control signals, is configured with at least one processor, searches for the network 300 by activating the second mobile communication module 213 in response to a user input, and performs a control to collect and output the type information of the found network 300 to the second display 240.

According to an embodiment of the present disclosure, the second control module 260 performs a control to activate the second short-range communication module 211 in response to a user input and search for the remote authentication available first electronic device 100. Alternatively, if there is an access unavailable network in the type information of the network 300, the second control module 260 searches for the first electronic device 100 that supports a remote authentication relating to the corresponding network 300. During this operation, the second control module 260 queries whether the first electronic device 100 is capable of accessing a corresponding network by delivering access unavailable network related information to the first electronic device 100. The first electronic device 100 automatically performs remote authentication processing in an accessible network.

According to embodiments of the present disclosure, the second control module 260 collects subscription information of the first electronic device 100 connected through the second short-range communication module 211 and based on this, searches for an accessible network 300. If an accessible network is found based on the subscription information of the first electronic device 100, the second control module 260 requests a remote authentication for corresponding network access from the first electronic device 100 automatically or in correspondence to a user input.

The second control module 260 controls handover processing to the remotely authenticated network 300 during a handover process. For example, the second electronic device 200 includes a subscriber module using a communication service different from a communication service to which the first electronic device 100 is subscribed. In this case, the second electronic device 200 uses a communication service by using a network for supporting another communication service, based on the second mobile communication module 213. When the handover of a network supporting another communication service occurs, the second control module 260 includes a remotely authenticable network through the first electronic device 100 in a target network for handover. The second control module 260 performs a control to collect communication environment information of a network of a communication service provider to which the second control module 260 subscribes and a network that is remotely authenticable through the first electronic device 100.

The following are aspects according to embodiments of the present disclosure, as described above:

A second electronic device includes a short-range communication module for establishing a short-range communication channel with a remote authentication available remote authentication device and a control module for receiving remote authentication information from the remote authentication device and processing a specified network connection by using the remote authentication information.

The control module performs a control to collect connectible network information from the remote authentication device and search for a connectible AP around based on the network information.

The control module performs a control to transmit connectible network information to a connected electronic device through the short-range communication channel, based on network service use available subscription information.

The control module performs a control to compare wireless environments of its network information and collected network information and performs network connection by using network information having a relatively good wireless environment.

The control module performs a control to request remote authentication information updated in a specific period from the remote authentication device.

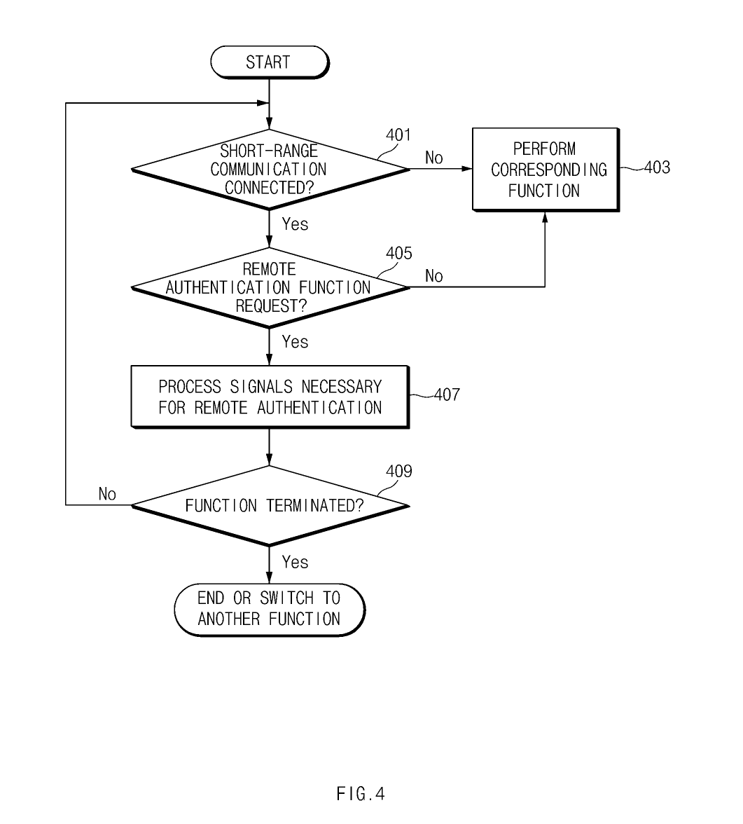

FIG. 4 illustrates a first electronic device operating method according to embodiments of the present disclosure.

Referring to FIG. 4, when an event occurs, the first control module 160 determines whether the event relates to a short-range communication connection in step 401. The first electronic device 100 maintains the first short-range communication module 111 to be in a communication connection available state. If an event is unrelated to the short-range communication connection, in step 403, the first control module 160 performs processing to perform a corresponding function according to an event type. For example, the first control module 160 performs a user function such as a health care, call, exercise measurement, or file playback function supported by the first electronic device 100 according to an event type. If no additional event occurs, the first control module 160 performs a control to maintain a sleep state or activate a specified user function.

If an event relating to a second communication channel operation occurs, in step 405, the first control module 160 determines whether a remote authentication function request occurs. If there is no remote authentication function request, the first control module 160 processes a specified function performance according to a short-range communication connection state. For example, the first control module 160 performs a screen output corresponding to short-range communication connection and an output of information relating to a connected electronic device. Alternatively, the first control module 160 transmits specified information such as sensor measurement information to a short-range communication connected electronic device or receives specified information such as file playback data or a call connection request message from the second control module 260.

If an event relating to a remote authentication function request occurs, in step 407, the first control module 160 performs signal processing necessary for remote authentication. For example, the first control module 160 performs a control to transmit subscription information stored in the subscriber module 150 to the short-range communication connected second electronic device 200. The first control module 160 processes the reception of authentication check information of the network 300 that requires remote authentication from the second electronic device 200. The first control module 160 performs an authentication on the received authentication check information and transmits an authentication message or an authentication key to the second electronic device 200.

In step 409, the first control module 160 determines whether there is an event occurrence relating to function termination. If there is no function termination related event, the first control module 160 returns to step 401 and re-performs the subsequent operations. When a function termination related event occurs, the first control module 160 releases a short-range communication connection and controls function processing according to a specified schedule. For example, the first control module 160 performs processing such as turning off the first electronic device 100, switching to a function performed before short-range communication connection, or switching to a lock screen. Additionally, when a specified time elapses after the remote authentication processing performance or when a specified time elapses when no additional signal is received from the second electronic device 200, the first control module 160 terminates remote authentication processing. During a function termination process, the first control module 160 releases a communication channel with the second electronic device 200 or maintains the communication channel according to a setting.

The following are aspects according to embodiments of the present disclosure, as described above:

An electronic device operating method includes establishing, by an electronic device, a short-range security communication channel with an external electronic device, and transmitting, to the external electronic device, network connection service use available remote authentication information according to a specified schedule or user input based on the short-range security communication channel.

Transmitting the network connection service use available remote authentication information includes transmitting the remote authentication information to the external electronic device in a specific period, receiving a remote authentication request message from the external electronic device and transmitting the remote authentication information to the external electronic device that transmits the remote authentication request message, receiving a plurality of remote authentication request messages from a plurality of external electronic devices and transmitting remote authentication information corresponding to each of the remote authentication request messages to the external electronic devices, and when a short-range communication channel with a specified external electronic device is established, automatically transmitting the remote authentication information to the specified external electronic device.

The method further includes outputting information relating to the remote authentication request of the external electronic device.

Transmitting of the network connection service use available remote authentication information includes, when an input signal for accepting the remote authentication request occurs, transmitting the remote authentication information to the external electronic device, transmitting remote authentication information that limits network connection characteristics of the external electronic device according to a user setting or a design method, and transmitting remote authentication information that limits network connection characteristics according to a type of the external electronic device.

The method further includes use of a screen interface for adjusting network connection characteristics.

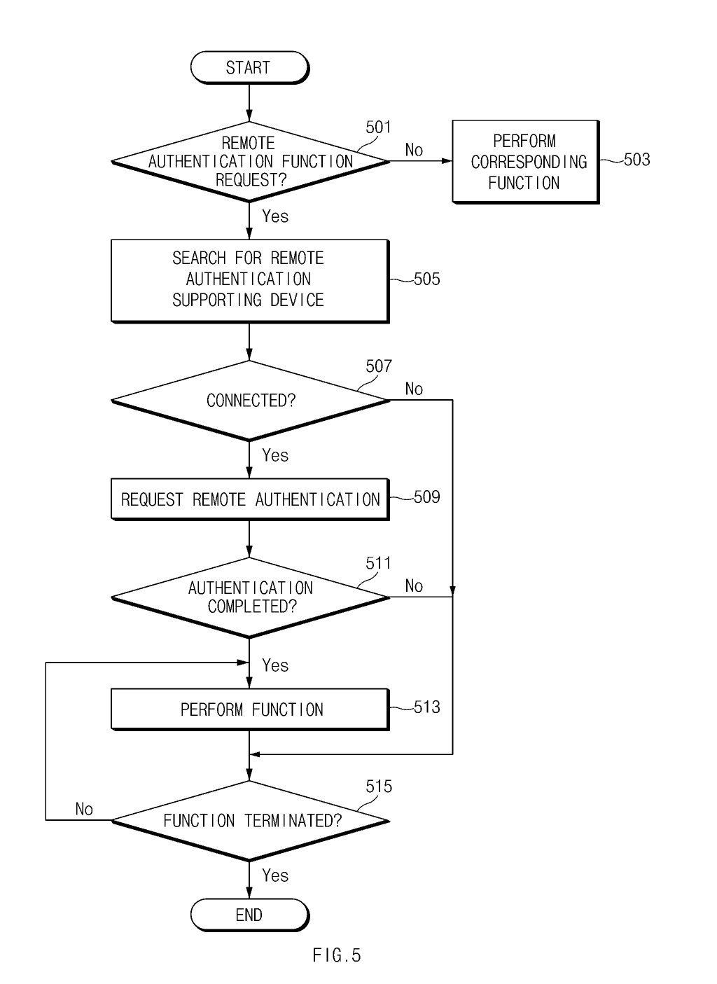

FIG. 5 illustrates a second electronic device operating method according to embodiments of the present disclosure.

Referring to FIG. 5, when an event occurs, the second control module 260 determines whether the event relates to a remote authentication function request in step 501. The second control module 260 outputs a menu item or icon relating to a remote authentication function performance to the second display 240.

If the event does not relate to a remote authentication function request, the second control module 260 processes a function performance according to an event type in step 503. For example, in an event relating to file playback, the second control module 260 plays a file specified by the event, and processes an information output according to the file.

If an event relating to a remote authentication function request occurs, in step 505, the second control module 260 performs a remote authentication supporting device search. The event relating to a remote authentication function request includes an event for selecting a specified menu item or icon, an event for requesting to activate the second short-range communication module 211, and an event according to an inaccessible network search. If an event relating to a remote authentication function request occurs, the second control module 260 performs a surrounding scan by activating the second communication module 210.

In step 507, the second control module 260 determines whether it is connected to the first electronic device 100 for supporting remote authentication. When the connection of the first electronic device 100 is performed, the second control module 260 requests a remote authentication in step 509. During this operation, the second control module 260 outputs a search list of devices discovered in the vicinity of the second control module 260. When a specific electronic device is selected from the search list, the second control module 260 transmits a message for requesting a remote authentication to the selected specific electronic device. The second control module 260 may provide a remote authentication available electronic device as an additional list or may process providing an display effect associated with a remote authentication available electronic device to have a difference with respect to other surrounding search items. The second control module 260 provides type information on the accessible network 300 through a remote authentication available electronic device.

In step 511, the second control module 260 determines whether authentication is completed based on a connected electronic device. If the authentication fails, the second control module 260 skips step 513. In step 507, if a surrounding device search fails, the second control module 260 skips steps 509, 511, and 513. If the authentication is completed, in step 513, the second control module 260 processes a communication service function performance based on remote authentication.

In step 515, the second control module 260 determines whether there is an event occurrence relating to function termination, such as an event for instructing a user's interne network access service termination, a valid time of authentication information used in an authentication procedure elapses as a specific time elapses, releasing a short-range communication connection with the first electronic device 100, and elapse of a specified time after a short-range communication connection with the first electronic device 100 is released. The function termination related event includes a remote authentication invalid processing event according to a user control of the first electronic device 100. If there is no function termination event occurrence, the second control module 260 returns to step 513 and supports communication service use according to remote authentication.

Although an operation for searching for the first electronic device 100 after a remote authentication request and performing a short-range communication connection is described above, embodiments of the present disclosure are not limited thereto. For example, the second electronic device 200 may receive a remote authentication function request when connected to the first electronic device 100 through short-range communication. In this case, the second control module 260 of the second electronic device 200 searches for an accessible network based on subscription information received from the first electronic device 100 and requests remote authentication by providing the found network related information to the first electronic device 100.

The following are aspects according to embodiments of the present disclosure, as described above:

A second electronic device operating method includes establishing a short-range communication channel with a remote authentication available remote authentication device, receiving remote authentication information from the remote authentication device, and processing a specified network connection by using the remote authentication information.

The method further includes collecting connectible network information from the remote authentication device and searching for a connectible AP around based on the network information.

The method further includes transmitting connectible network information to a connected electronic device through the short-range communication channel, based on network service use available subscription information.

Processing the specified network connection includes comparing wireless environments of its network information and collected network information and performing network connection by using network information having a relatively good wireless environment.

The method further includes requesting remote authentication information updated in a specific period from the remote authentication device.

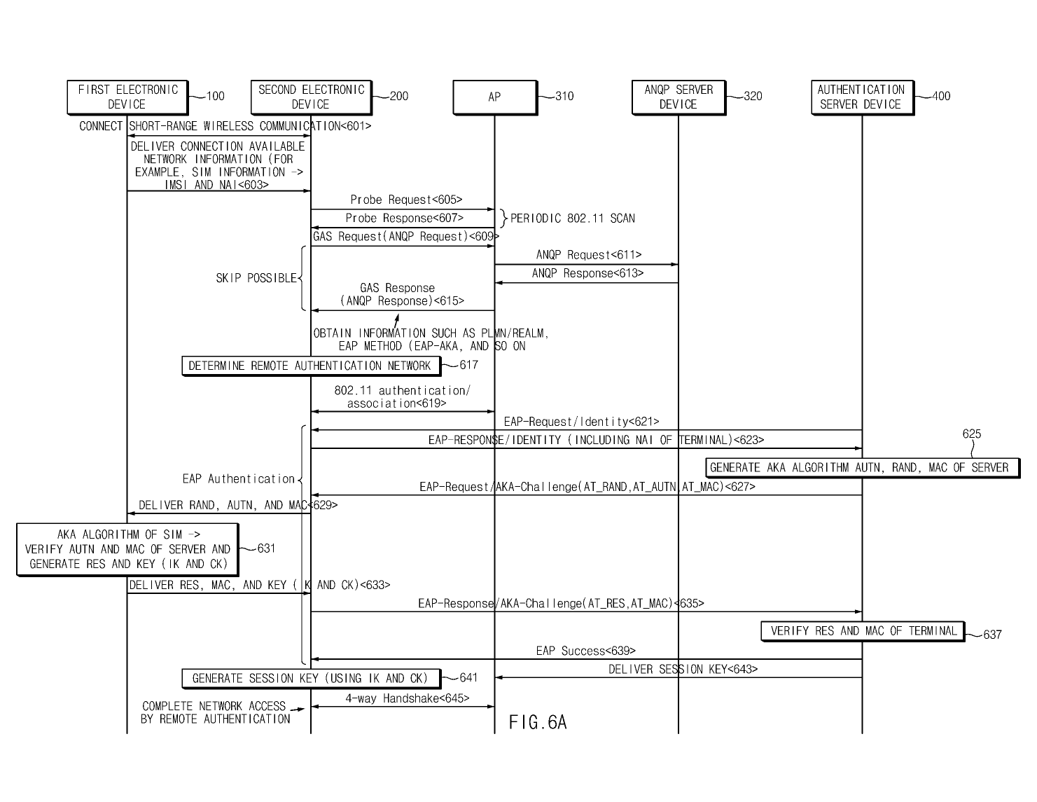

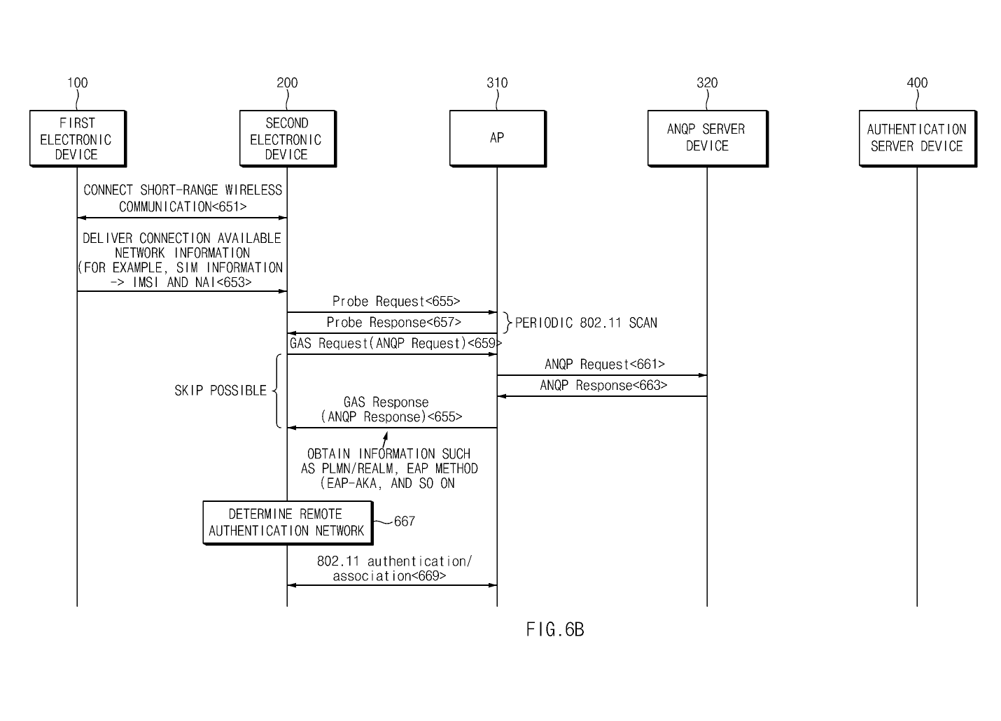

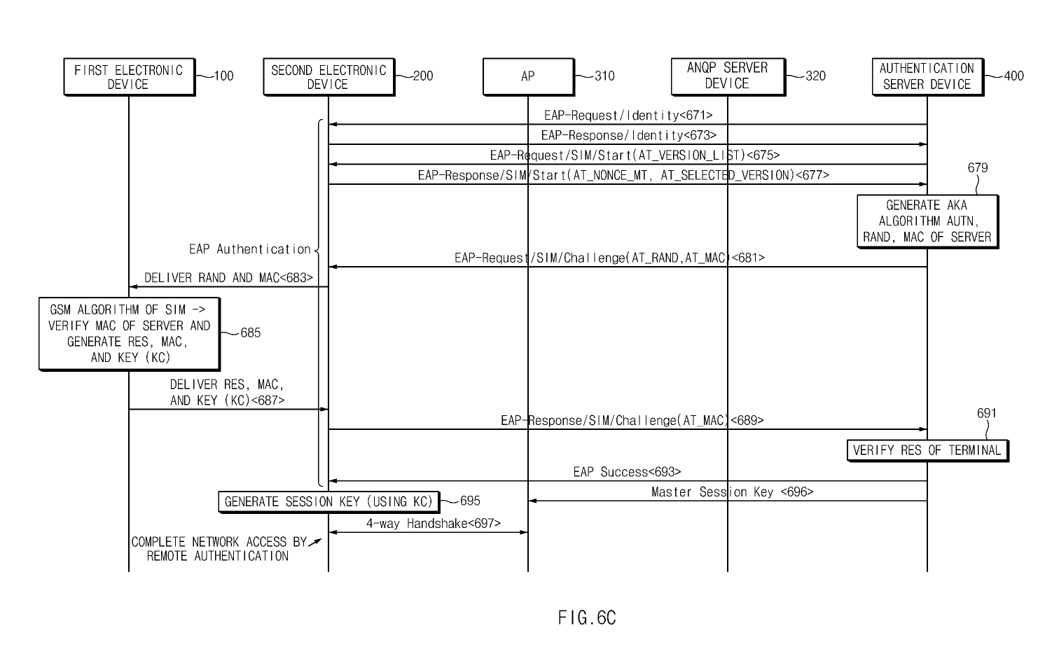

FIG. 6A illustrates a remote authentication procedure according to embodiments of the present disclosure.

Referring to FIG. 6A, the first electronic device 100 and the second electronic device 200 perform short-range wireless communication connection between each other in step 601. The first electronic device 100 and the second electronic device 200 establish a secure communication channel through short-range wireless communication connection such as WiFi, BT, or Zigbee®.

In step 603, the first electronic device 100 delivers, to the second electronic device 200, subscription information that the first electronic device 100 has and network information that the first electronic device 100 uses through a secure channel. For example, the first electronic device 100 delivers connectable network information to the second electronic device 200.

The second electronic device 200 performs a periodic SCAN such as a Probe Request/Response exchange for searching for WiFi network in relation to a WiFi function performance. For example, when connectable network information is obtained, the second electronic device 200 transmits a Probe request message to AP 310 in step 605 and receives a Prove response from AP 310 in step 607. The second electronic device 200 performs a scan operation with the surrounding APs 310 over all channels and the second electronic device 200 collects AP information such as an SSID or capability information. The obtained information of AP 310 includes a field representing whether to support 802.11u and Passpoint.

The second electronic device 200 performs 802.11u discovery on APs 310 supporting 802.11u and Passpoint. The second electronic device 200 transmits a generic advertisement service (GAS) Request message to AP 310 in step 609. AP 310 transmits an ANQP Request message to the ANQP server device 320 in step 611. AP 310 receives an ANQP Response message from the ANQP server device 320 in step 613, and then transmits a GAS Response message to the second electronic device 200 in step 615.

During the above-mentioned operation, the second electronic device 200 uses an Advertisement Protocol that is called an ANQP provided from Hotspot 2.0 network. In relation to the communication between AP 310 and the ANQP server 320, GAS protocol is decoded, so that only an ANQP request/response may be performed. By performing steps 609 to 615, the second electronic device 200 obtains various information stored in an ANQP server through 802.11u discovery. For example, the second electronic device 200 obtains a PLMN and Realm that is operator information that configures a Hotspot 2.0 network and an EAP-AKA connection method for accessing the network 300. It is noted that step 609 to step 615 may be omitted.

In step 617, the second electronic device 200 determines a remote authentication network, such as a connectable network by comparing network operator information obtained through 802.11u and an IMSI value. For example, the second electronic device 200 determines whether there is a network matching various subscription information already owned by the second electronic device 200 by using SIM information from the first electronic device 100. If a plurality of connectable networks is found, the second electronic device 200 selects at least one network, such as a network with a relatively good wireless environment or a network having a wireless environment above a specified reference value.

According to embodiments of the present disclosure, although a process for obtaining remote authentication check information based on Hotspot 2.0 network is described, the second electronic device 200 may be connected by using an SSID obtained through scan and may pre-define and store network operator information. In this case, the second electronic device 200 omits an 802.11u process by determining whether it is a connectable network only with the SSID that is the name of AP 310 obtained through scan. Alternatively, when network information is obtained through an 802.11u process and a connection process is completed successfully, the second electronic device 200 performs connection by matching the SSID or homogenous extended SSID (HESSID) information obtained through scan, and stores network information. In this case, the second electronic device 200 omits an 802.11u process from the second connection process.

In step 619, the second electronic device 200 performs 802.11 authentication/association (or registration) with AP 310. For example, when it is determined that a network matching subscription information obtained from the first electronic device 100 requires remote authentication, the second electronic device 200 performs a connection process including an EAP authentication. The above-mentioned connection process may include an 802.11 authentication/association process, an EAP authentication process, and a 4-way handshake process. The 802.11 authentication/association process is for performing a connection between AP 310 and the second electronic device 200 in a non-security mode in order to establish a communication channel for EAP authentication.

In step 621, the authentication server device 400 transmits an EAP-Request/Identify message to the second electronic device 200. According to an embodiment of the present disclosure, the authentication server device 400 is connected to a switch router and transmits an EAP-Request/Identify message to the second electronic device 200 through AP 310 connected to a switch router. The EAP authentication, as an authentication process between the second electronic device 200 and the authentication server device 400, represents an EAP authentication process when the network 300 supports an EAP-AKA authentication.

In step 623, the second electronic device 200 transmits a message of an EAP-Response/Identity (including the NAI of the first electronic device 100) to the authentication server device 400. For example, the authentication server device 400 starts an EAP-AKA authentication with an EAP-request/Identity message and in response to this, the second electronic device 200 replies with an EAP-Response/Identity including the NAI obtained from the first electronic device 100.

In step 625, the authentication server device 400 generates an authentication token (AUTN), random challenge (RAND), and media access control (MAC) based on a stored AKA algorithm. In step 627, the authentication server device 400 transmits an EAP-Request/AKA-Challenge (that is, AT_RAND, AT_AUTN, and AT_MAC) message to the second electronic device 200. When receiving the EAP-Request/AKA-Challenge message from the authentication server device 400, the second electronic device 200 delivers RAND, AUTN, and MAC information to the first electronic device 100 in step 629. During this process, the second electronic device 200 extracts RAND, AUTN, and MAC values by interpreting the EAP-Request/AKA-Challenge message and delivers these values through a secure channel of a short-range wireless communication established with the first electronic device 100.

In step 631, the first electronic device 100 performs verification on AUTN and MAC provided from the authentication server device 400 by using an AKA algorithm of SIM and generates an authentication response (RES) and keys including an integrity key (IK) and cipher key (CK). During this operation, the first electronic device 100 receives corresponding RAND, AUTN, and MAC values through a remote authentication module and performs an AKA algorithm in SIM by using corresponding values as an input. The SIM 150 of the first electronic device 100 verifies whether the AUTN and MAC values transmitted from the authentication server device 400 are normal values through an AKA algorithm and generates the RES, IK, and CK values. In step 633, the first electronic device 100 transmits the generated RES and keys to the second electronic device 200. In step 635, the second electronic device 200 transmits an EAP-Response/AKA-Challenge (that is, AT_RES and AT_MAC) message to the authentication server device 400. During this operation, the second electronic device 200 includes a MAC value in AT_RES and AT_MAC formats, which is generated by using the RES value and the key value delivered from the first electronic device 100, in the EAP-Response/AKA-Challenge message, and transmits the message to the authentication server device 400.

In step 637, the authentication server device 400 performs the RES and MAC verification of the first electronic device 100. If the verification is completed successfully, the authentication server device 400 terminates the EAP authentication process while providing an EAP success message to the second electronic device 200 in step 639. The second electronic device 200 receiving the EAP success message generates a session key by using the IK and CK in step 641. In step 643, however, the authentication server device 400 delivers a session key to AP 310. Herein, steps 641 and 643 may be performed concurrently.

The second electronic device 200 and AP 310 establish a communication channel for communication service use through a 4-way handshake in step 645. Accordingly, the second electronic device 200 performs a remote authentication based network access using the first electronic device 100.

FIGS. 6B and 6C illustrate a remote authentication procedure according to another embodiment of the present disclosure. The remote authentication procedure described with reference to FIG. 6A is a method of operating EAP-AKA and a remote authentication procedure described with reference to FIGS. 6B and 6C corresponds to an EAP-SIM authentication method used in a global system for mobile communications (GSM) network. Alternatively, the above-mentioned EAP-SIM and EAP-AKA may have a similar remote authentication procedure and AUTN of EAP-AKA may be omitted.

Prior to the description, steps 651 to 669 in the remote authentication procedure described with reference to FIG. 6B are identical to steps 601 to 619 in the remote authentication procedure of FIG. 6A, and thus will not be described.

Referring to FIGS. 6B and 6C, as an EAP authentication operation is described, the authentication server device 400 starts an EAP authentication by transmitting an EAP-Request/Identity message to the second electronic device 200 in step 671 and the second electronic device 200 delivers an EAP-Response/Identity message to the authentication server device 400 in step 673. The authentication server device 400 transmits, to the second electronic device 200, an EAP-Request/SIM/Start message (EAP-Request/SIM/Start (AT_VERSION_LIST)) including a version list of an EAP-SIM authentication supported by a server in step 675. The second electronic device 200 receiving a corresponding message selects one from the version list provided from the authentication server device 400 after interpreting the received message and loads the one in an AT_SELECTED_VERSION format, and generates a nonce that is a random value and transmits an EAP-Response/SIM/Start message (EAP-Response/SIM/Start (AT_NONCE_MT and AT_SELECTED_VERSION)) containing the nonce in an AT_NONCE_MT format to the authentication server device 400 in step 677.

The authentication server device 400 generates RAND and MAC values through a GSM algorithm based on the nonce value in the EAP-Response/SIM/Start response message received from the second electronic device 200 in step 679. In step 681, the authentication server device 400 loads the generated RAND and MAC values in an EAP-Request/SIM/Challenge message (EAP-Request/SIM/Challenge (AT_RAND and AT_MAC)) message and transmits this message to the second electronic device 200. The second electronic device 200 extracts RAND and MAC values by interpreting the message received from the authentication server device 400 and in step 683, delivers the RAND and MAC values to the first electronic device 100 in addition to the nonce value generated from the network access message. In step 685, the first electronic device 100 performs a GSM algorithm in the SIM by using the RAND and MAC values delivered from the second electronic device 200 as an input and verifies the MAC value of the authentication server device 400. When the verification is completed, the first electronic device 100 generates the RES and Key(Kc)(Kc may be key value) and delivers the RES and Key(Kc) to the second electronic device 200 in step 687.

The second electronic device 200 generates an EAP-Response/SIM/Challenge message (EAP-Response/SIM/Challenge (AT_MAC)) in an AT_MAC format by using a RES value delivered from the first electronic device 100 and a MAC value generated based on a Key and then transmits this message to the authentication server device 400 in step 689. The authentication server device 400 verifies the RES value received from the second electronic device 200 in step 691 and if there is no issue, terminates the authentication by transmitting an EAP success message to the second electronic device 200 in step 693.

In step 695, the second electronic device 200 generates a master session key based on the Kc transmitted by the first electronic device 100, and in step 696, the authentication server device 400 generates a master session key and delivers the master session key to AP 310. In step 697, the second electronic device 200 and AP 310 perform a 4-way handshake and establish a communication channel. For example, AP 310 may check the master session key received from the second electronic device 200 based on the master session key received from the authentication server device 400. When the master session key received from the second electronic device 200 is the same with the master session key received from the authentication server device 400, AP 310 may establish the communication channel.

The remote authentication procedure in steps 691 to 697 may be identical to that in steps 637 to 645 shown in FIG. 6A.

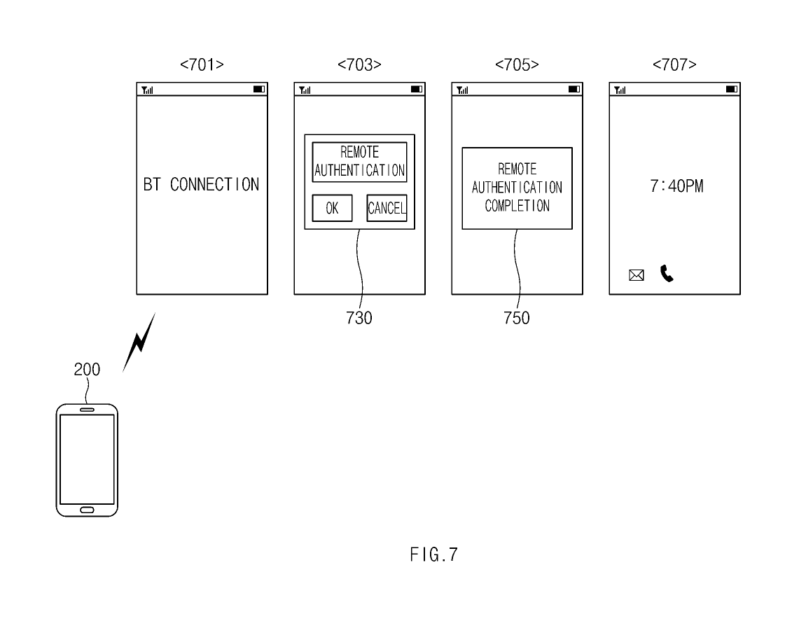

FIG. 7 illustrates a screen interface of a first electronic device according to embodiments of the present disclosure.

Referring to FIG. 7, the first display 140 of the first electronic device 100, as shown in screen 701, outputs information or a screen relating to a short-range communication connection with the second electronic device 200.

The first electronic device 100 maintains a short-range communication connectable state or has a state of receiving a beacon signal transmitted by the second electronic device 200. Alternatively, the first electronic device 100 establishes a BT communication channel by transmitting/receiving a pairing related signal to/from the second electronic device 200. The illustrated “BT connection” display may be changed according to the type of a short-range communication channel established between the first electronic device 100 and the second electronic device 200. “BT connection” represents one example of a short-range communication channel through which the first electronic device 100 and the second electronic device 200 perform data transmission/reception.

The first electronic device 100 receives a remote authentication request related message from the second electronic device 200. Alternatively, when establishing a short-range communication channel with the second electronic device 200, the first electronic device 100 may automatically determine an occurrence of a remote authentication request. The first electronic device 100 stores the identification information of the second electronic device 200 and when connecting to the second electronic device 200, stores setting information for automatically determining an occurrence of a remote authentication request.

According to embodiments of the present disclosure, the second electronic device 200 may be recorded as an electronic device having a history for performing remote authentication processing in the first electronic device 100. Accordingly, when connecting to the second electronic device 200, the second display 240 of the first electronic device 100 outputs a pop-up window for inquiring as to whether to perform remote authentication as shown in screen 703 relating to simple connection support. According to embodiments of the present disclosure, if remote authentication processing is set to be performed automatically as the first electronic device 100 is connected to the second electronic device 200, the remote authentication pop-up window 730 shown in screen 703 may be omitted.

The first electronic device 100 performs remote authentication in correspondence to a user input or in correspondence to an automatic or specified scheduling event and outputs a screen according thereto. For example, the second display 240 outputs information according to a remote authentication completion or guide information 750 corresponding to a screen as shown in screen 705. The second display 240 outputs a specified screen after remote authentication completion, such as a standby screen or a home screen, as shown in screen 707. Alternatively, the second display 240 outputs a screen corresponding to a function performed before a short-range communication connection or a remote authentication function performance of the second electronic device 200. If a remote authentication procedure of the first electronic device 100 is set to be processed in a background processing state, a screen output relating to remote authentication processing of the second display 240 may be omitted.

According to an embodiment of the present disclosure, the first electronic device 100 may be in a smart watch form, and the smart watch extracts network information from SIM information and delivers the extracted information and an authentication method (EAP-SIM/AKAK/AKA) to a tablet electronic device corresponding to the second electronic device 200 through various communication methods, such as BLE beacon, NAN, and NFC. Accordingly, screens 701 to 707 may be provided from the smart watch. As a device equipped with network connection information and a remote authentication module, the smart watch may be replaced with various wearable or accessory product forms. For example, a specific hotel or business may provice an accessory product including authentication information of a hotel network to limited customers who may access the network by using his/her own electronic device and the provided accessory product. According to embodiments of the present disclosure, the number of available networks or the rating of an accessory product may vary and the differentiated accessory product may be sold or rented to specified customers.

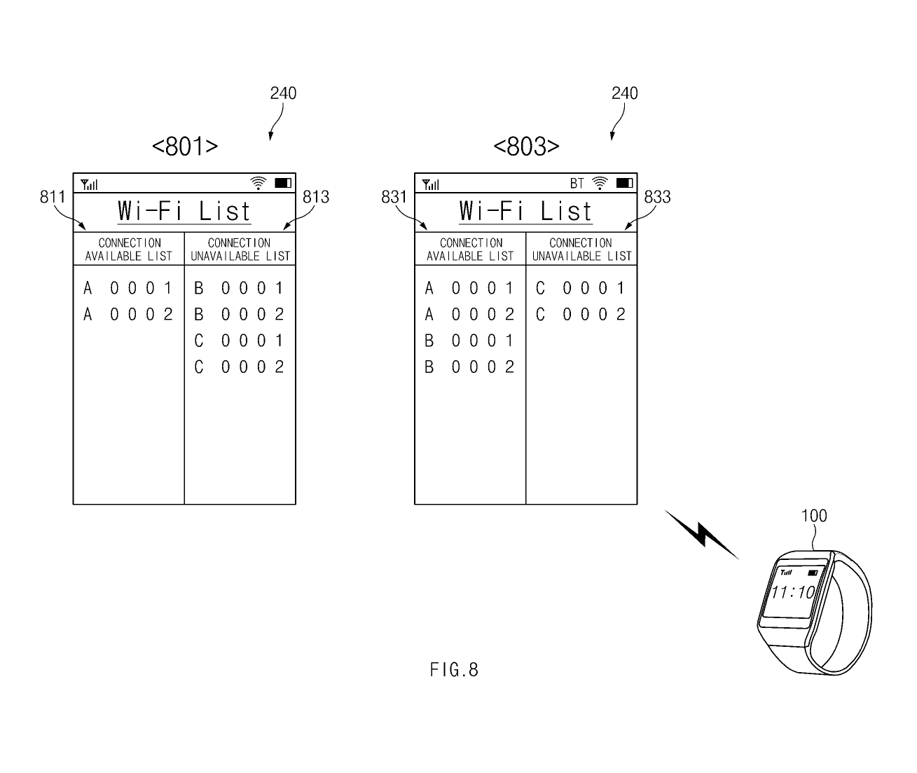

FIG. 8 illustrates a screen interface of a second electronic device according to embodiments of the present disclosure.

Referring to FIG. 8, the second electronic device not connected to the first electronic device 100 performs surrounding search according to a user input or a specified scheduling event. Accordingly, the second display 240 of the second electronic device 200 outputs found information as shown in screen 801. The search information screen includes a first connection available list item 811 and a first connection unavailable list item 813.

The first connection available list item 811 includes information on connectable APs or networks based on SIM information included in the second electronic device 200. For example, when the second electronic device 200 is subscribed to a first network service provider and registers SIM information, the first connection available list item 811 includes information on APs or networks provided by the first network service provider.

The first connection unavailable list item 813 includes information on not-connectable APs or networks as the second electronic device 200 uses currently stored SIM information. For example, the first connection unavailable list item 813 is information on APs B0001 and B0002 of a second network service provider to which the second electronic device 200 is not subscribed and APs C0001 and C0002 of a third network service provider to which the second electronic device 200 is not subscribed.

According to embodiments of the present disclosure, the second electronic device 200 not connected to the first electronic device 100 performs surrounding search and outputs found information as shown in screen 803. The search information screen includes a second connection available list item 831 and a second connection unavailable list item 833.

The second connection available list item 831 is information on APs (or networks) accessible as the second electronic device uses its the SIM information and the SIM information stored in the first electronic device 100 when connected to the first electronic device 100. For example, APs A0001 and A0002 of the first network service provider are information on APs accessible using the SIM information stored in the second electronic device 200 and APs B0001 and B0002 of the second network service provider are information on APs accessible as the second electronic device 200 performs remote authentication by using the SIM information stored in the first electronic device 100.

The second connection unavailable list item 833 is information on APs APs C0001 and C0002 of the third network service provider, inaccessible even when the SIM information of the first electronic device 100 and the SI information of the second electronic device 200 are used. For example, when a third electronic device registered in the third network service provider is connected to at least one of the first electronic device 100 and the second electronic device 200 and performs remote authentication, APs C0001 and C0002 of the third network service provider are included in a connection available list item of the second electronic device 200.

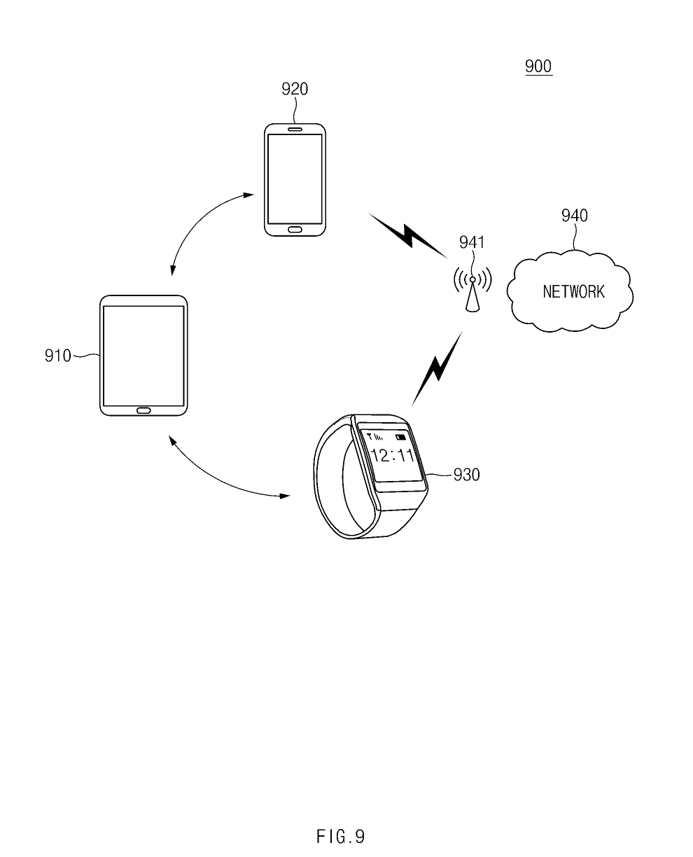

FIG. 9 illustrates a plurality of remote authentication functions according to embodiments of the present disclosure.

Referring to FIG. 9, a communication service using environment 900 includes a remote authentication device 910 (for example, the first electronic device 100), a first remote authentication request device 920 (for example, the second electronic device 100), a second remote authentication request device 930 (for example, another second electronic device), an AP 941, and a network 940. The communication service using environment 900 may further include an authentication server device connected to the network 940 and an Internet network. The above-mentioned communication service using environment 900 may be an environment in which a central device providing remote authentication in a specific venue, home, school, or business environment is provided as the remote authentication device 910.

The remote authentication device 910 provides remote authentication network information and a method in a specified venue through the above-mentioned various methods. When at least one remote authentication request device accesses the specified venue, the accessing remote authentication request device accesses a network through the remote authentication device 910. At this point, a network that the remote authentication device 910 provides may be limited by guest network information differentiated from an existing user. The remote authentication device 910 permits the network connection of a surrounding remote authentication request device through remote authentication and concurrently obtains a right for controlling the connection of each remote authentication request device. The remote authentication device 910 includes information such as the network name and identifier (ID) of an available network for providing remote authentication to a remote authentication request device through a method such as short-range or wired communication, and cloud, and information for a device providing remote authentication, and delivers this information. The above-mentioned remote authentication device 910 is equipped with a module responsible for remote authentication of a surrounding remote authentication request device.

The first remote authentication request device 920 includes a communication module for establishing a short-range communication channel with the remote authentication device 910. Alternatively, the first remote authentication request device 920 includes a communication module for communicating with AP 941. The first remote authentication request device 920 receives and stores connectable network information from the remote authentication device 910. When network is found by using corresponding network information, the first remote authentication request device 920 transmits network connection related processing to the remote authentication device 910. The first remote authentication request device 920 may be various devices such as a smartphone, a tablet device, and a slate computing device.

The second remote authentication request device 930 includes a communication module for establishing a short-range communication channel with the remote authentication device 910. Alternatively, the second remote authentication request device 930 includes a communication module for communicating with AP 941. The second remote authentication request device 930 receives a remote authentication for a specified network from the remote authentication device 910 when the first remote authentication request device 920 receives a remote authentication for a specified network through the remote authentication device 910. The first remote authentication request device 920 and the second remote authentication request device 930 are within a specific range for establishing a short-range communication channel with the remote authentication device 910. According to an embodiment of the present disclosure, the first remote authentication request device 920 and the second remote authentication request device 930 may be an electronic device within a specific range and are movable or stationary electronic devices during the communication channel establishment process.

AP 941 is for establishing a communication channel with the first remote authentication request device 920 and the second remote authentication request device 930. AP 941 processes the network service support related signal transmission/reception of the first remote authentication request device 920 or the second remote authentication request device 930, and delivers signals received from the first remote authentication request device 920 or the second remote authentication request device 930 to the specified network 940 or delivers signals from the specified network 940 to the first remote authentication request device 920 or the second remote authentication request device 930. AP 941 supports a connection with the specified network 940.

The network 940 supports a network service of a specified electronic device through AP 941. For example, when authentication is completed, the network 940 supports the network service of the remote authentication device 910, and supports the network service of the first remote authentication request device 920 or the second remote authentication request device 930, which is remotely authenticated. According to embodiments of the present disclosure, when remote authentication is completed according to a specified period, the network 940 requests re-authentication of the first remote authentication request device 920 or the second remote authentication request device 930.

The remote authentication device 910 and the first remote authentication request device 920 or the second remote authentication request device 930 process remote authentication related signal transmission/reception by using at least one of a low power advertising method such as BLE beacon and WiFi NAN and a transmission method using proximity service such as Zigbee and NFC. During this operation, the remote authentication device 910 delivers network information, through a secure connection channel, to a remote authentication request device of which short-range communication connection is completed securely. As another example, the remote authentication device 910 obtains remote authentication available network information and a remote authentication method, and information on a device providing remote authentication and location information, from a cloud server. In this case, the remote authentication request device may additionally discover a remote authentication device providing remote authentication.

The remote authentication device 910 limits network connection characteristics according to a setting. For example, the remote authentication device 910 limits the number of available network connections of a remote authentication request device according to a user's setting adjustment or limits a network connection available time of a remote authentication request device. The remote authentication device 910 is designed in various grades to limit network connection characteristics during a manufacturing process. Alternatively, the remote authentication device 910 outputs a screen interface relating to an adjustment of network connection characteristics. When a setting is adjusted through the screen interface, the remote authentication device 910 delivers related information to the network 940 in order to limit the network connection characteristics of a remote authentication request device according to specified network connection characteristics. The network 940 limits network connection characteristics of a remote authentication request device that the remote authentication device 100 authenticates remotely according to a request of the remote authentication device 910.

According to embodiments of the present disclosure, the remote authentication device 910 varies network connection characteristics of a remote authentication request device in correspondence to the type of a remote authentication device (or an external electronic device) or device identification information of a remote authentication device. For example, when a remote authentication request device owned by a specified user or a specified type of a remote authentication request device requests remote authentication, the remote authentication device 910 provides remote authentication information having no network connection limitations to the remote authentication request device. Alternatively, when receiving a remote authentication request from a remote authentication request device owned by a user of a specified grade or a remote authentication request device having a specified grade, the remote authentication device 910 provides a specific network connection limited remote authentication information. The specified type, grade, and device identification information may be inputted through an input means of the remote authentication device 910 or collected from a specified server device.

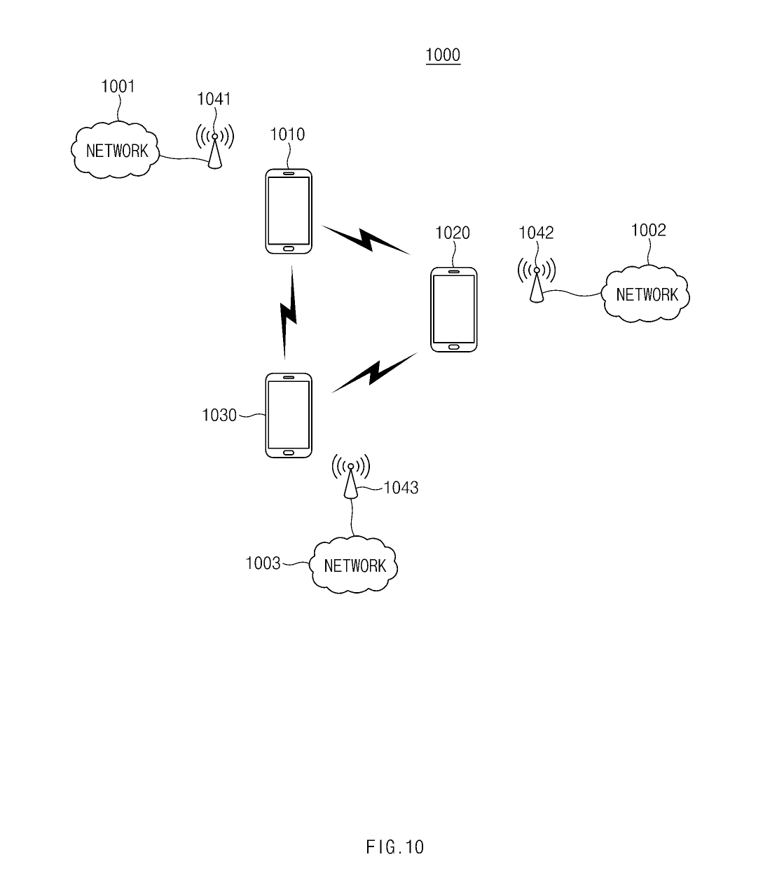

FIG. 10 illustrates a remote authentication information sharing environment according to embodiments of the present disclosure.

Referring to FIG. 10, a remote authentication information sharing environment 1000 includes a first sharing electronic device 1010, a second sharing electronic device 1020, and a third sharing electronic device 1030, and includes a first AP 1041, a second AP 1042, a third AP 1043, a first network 1001, a second network 1002, and a third network 1003. The remote authentication information sharing environment 1000 may further include a first authentication server device, a second authentication server device, and a third authentication server device, and at least one ANQP server device connected to each authentication server device.

The sharing electronic devices 1010, 1020, and 1030 share remote authentication information mutually when a secure connection group is generated between devices. Then, the sharing electronic devices 1010, 1020, and 1030 selectively provide remote authentication according to a state of a surrounding network. The first sharing electronic device 1010 stores first subscriber information for connection of each first network 1001. The second sharing electronic device 1020 stores second subscriber information for connection of each second network 1002. The third sharing electronic device 1030 stores third subscriber information for connection of each third network 1003.

The sharing electronic devices 1010, 1020, and 1030 are connected in a WiFi based low power discovery technique, such as NAN. The sharing electronic devices 1010, 1020, and 1030 are synchronized with a NAN cluster network and exchange beacon and service discovery frames within a synchronized discovery window (DW). In a section besides the DW, the sharing electronic devices 1010, 1020, and 1030 maintain a discovery state at all times in low power by maintaining a sleep state.

The first AP 1041 is connected to the first network 1001 serviced by a first network service provider. According to an embodiment of the present disclosure, the first sharing electronic device 1010 is connected to the first network 1001 through the first AP 1041, and the second AP 1042 is connected to the second network 1002 serviced by a second network service provider. According to an embodiment of the present disclosure, the second sharing electronic device 1020 is connected to the second network 1002 through the second AP 1042, the third AP 1043 is connected to the third network 1003 serviced by a third network service provider, and the third sharing electronic device 1030 is connected to the third network 1003 through the third AP 1043.

The first sharing electronic device 1010 is connected to various networks according to a connected state based on a short-range communication channel. For example, when establishing a short-range communication channel with the third sharing electronic device 1030, the first sharing electronic device 1010 connects to the third network 1003 based on the remote authentication of the third sharing electronic device 1030. When establishing a short-range communication channel with the third sharing electronic device 1030, the second sharing electronic device 1020 connects to the third network 1003 based on the remote authentication of the third sharing electronic device 1030. When establishing a short-range communication channel with the first sharing electronic device 1010 and the second sharing electronic device 1020, the third sharing electronic device 1030 connects to the first network 1001 and the second network 1002 based on the remote authentication of the first sharing electronic device 1010 and the second sharing electronic device 1020.

As mentioned above, according to embodiments of the present disclosure, a control module of a specific electronic device collects connectable network information from a surrounding device and performs a control to connect to a network that satisfies a specified condition among the collected network information and the stored network information.

A specified electronic device obtains remote authentication available network information from a surrounding device. A specified electronic device selects a network for an optimal connection from a network list including all stored network information and remote authentication available network information through a discovery such as WiFi SCAN, and 802.11u scan. When the selected network includes existing connection information and credential, a specified electronic device performs connection immediately through self authentication.

According to embodiments of the present disclosure, when the selected network is a remote authentication available network obtained from a surrounding device, a specified electronic device determines whether it is connected to a surrounding device that provides corresponding remote authentication information and, when connected, performs network connection through a corresponding surrounding device and remote authentication. If not connected to a surrounding device that provides remote authentication, a specified electronic device performs a device discovery such as WiFi P2P discovery and BT SCAN for searching for a corresponding surrounding device, and performs network connection through remote authentication after the connection with a surrounding device that provides remote authentication. If a device providing remote authentication is not found, a specified electronic device may re-select an optimal network except for the currently selected network.

According to embodiments of the present disclosure, in connecting a short-range communication network, a specified electronic device supports access to a network through remote authentication by using connection information of a surrounding device without connection information on network. According to the present disclosure, since an electronic device uses all available surrounding network connection information, the electronic device broadens a network connection range and security may be maintained through a remotely authenticating method instead of a method of directly delivering connection information of a surrounding device.

According to embodiments of the present disclosure, the present disclosure supports an unsubscribed service network based on remote authentication.

The present disclosure uses a broader communication coverage by sharing subscribed service network connection characteristics and supports a relatively good quality communication service.

The term “module” used in embodiments of the present disclosure may indicate a unit including a combination of at least one of hardware, software, and firmware. The term “module” and the term “unit”, “logic”, “logical block”, “component”, or “circuit” may be interchangeably used. A “module” may be a minimum unit or part of an integrally configured component. A “module” may be a minimum unit performing at least one function or part thereof. A “module” may be implemented mechanically or electronically. For example, “module” according to embodiments of the present disclosure may include at least one of an application-specific integrated circuit (ASIC) chip performing certain operations, field-programmable gate arrays (FPGAs), or a programmable-logic device, all of which are known or to be developed in the future.

According to embodiments of the present disclosure, at least part of a device or a method according to this disclosure as in a form of a programming module, may be implemented using an instruction stored in computer-readable storage media. The instruction may be set to perform establishing a communication channel with an external electronic based on wired communication or short-range communication, obtaining a communication profile necessary for a second communication module operation for supporting base station based communication service by using the connected external electronic device, and storing the obtained communication profile.

A module or a programming module according to embodiments of the present disclosure may include at least one of the above-mentioned components, may not include some of the above-mentioned components, or may further include another component. Operations performed by a module, a programming module, or other components according to embodiments of the present disclosure may be executed through a sequential, parallel, repetitive or heuristic method, may be executed in a different order, and may be omitted, or other operations may be added.

Moreover, the embodiments disclosed in this specification are suggested for the description and understanding of technical content but do not limit the range of the present disclosure. Accordingly, the range of the present disclosure should be interpreted as including all modifications or various other embodiments based on the technical idea of the present disclosure.

Although certain embodiments are described herein, it will be understood by those skilled in the art that various changes in form and detail may be made therein without departing from the spirit and scope of the embodiments, as defined by the appended claims.

What is claimed is:

1. An electronic device comprising:
a memory that stores network connection service use available remote authentication information;
a first short-range communication module that establishes a short-range communication channel with an external electronic device; and
a processor functionally connected to the memory and the first short-range communication module,
wherein the processor controls to establish the short-range communication channel with the external electronic device and transmit the network connection service use available remote authentication information to the external electronic device in response to a specified schedule or a user input.

2. The electronic device of claim 1, wherein the processor provides the remote authentication information to the external electronic device in a specific period.

3. The electronic device of claim 1, wherein, when receiving a remote authentication request message, the processor transmits the remote authentication information to the external electronic device that transmits the remote authentication request message.

4. The electronic device of claim 1, wherein, when receiving a plurality of remote authentication request messages, the processor transmits remote authentication information corresponding to each of the remote authentication request messages to the external electronic devices.

5. The electronic device of claim 1, wherein, when establishing a short-range security communication channel with a specified external electronic device, the processor automatically transmits the remote authentication information to the specified external electronic device.

6. The electronic device of claim 1, wherein the processor outputs information relating to the remote authentication request of the external electronic device.

7. The electronic device of claim 6, wherein, when an input signal for accepting the remote authentication request occurs, the processor transmits the remote authentication information to the external electronic device.

8. The electronic device of claim 1, wherein the processor transmits remote authentication information that limits network connection characteristics of the external electronic device in response to a user setting or a design method.

9. The electronic device of claim 1, wherein the processor transmits remote authentication information that limits network connection characteristics in response to a type of the external electronic device.

10. The electronic device of claim 1, wherein the processor outputs a screen interface for adjusting network connection characteristics.

11. An electronic device operating method comprising:
establishing, by an electronic device, a short-range security communication channel with an external electronic device; and
transmitting, to the external electronic device, network connection service use available remote authentication information, in response to a specified schedule or a user input, based on the short-range security communication channel.

12. The method of claim 11, wherein transmitting the network connection service use available remote authentication information comprises transmitting the remote authentication information to the external electronic device in a specific period.

13. The method of claim 11, wherein transmitting the network connection service use available remote authentication information comprises:
receiving a remote authentication request message from the external electronic device; and
transmitting the remote authentication information to the external electronic device that transmits the remote authentication request message.

14. The method of claim 11, wherein transmitting the network connection service use available remote authentication information comprises:
receiving a plurality of remote authentication request messages from a plurality of external electronic devices; and
transmitting remote authentication information corresponding to each of the remote authentication request messages to the external electronic devices.

15. The method of claim 11, wherein transmitting the network connection service use available remote authentication information comprises, when a short-range communication channel with a specified external electronic device is established, automatically transmitting the remote authentication information to the specified external electronic device.

16. The method of claim 13, further comprising outputting information relating to the remote authentication request of the external electronic device.

17. The method of claim 16, wherein transmitting the network connection service use available remote authentication information comprises, when an input signal for accepting the remote authentication request occurs, transmitting the remote authentication information to the external electronic device.

18. The method of claim 11, wherein transmitting the network connection service use available remote authentication information comprises transmitting remote authentication information that limits network connection characteristics of the external electronic device in response to a user setting or a design method.

19. The method of claim 11, wherein transmitting the network connection service use available remote authentication information comprises transmitting remote authentication information that limits network connection characteristics in response to a type of the external electronic device.

20. The method of claim 11, further comprising a screen interface for adjusting network connection characteristics.
